(19) United States
(12) Patent Application Publication
(10) Pub. No.: US 2015/0206201 A1
(43) Pub. Date: Jul. 23, 2015

(54) Computerized System for Managing the Distribution of Corporate Donations

(71) Applicants: XPEREDON Group S.A., Luxembourg (LU); XPIP LTD, Castries (LC)

(72) Inventor: Julian Otto Worth, Lauenen bei Gstaad (CH)

(21) Appl. No.: 14/116,081

(22) PCT Filed: May 12, 2012
(86) PCT No.: PCT/IB12/52373

§ 371 Date: Nov. 6, 2013

(51) Int. Cl. G06Q 30/02; G07C 13/00

(52) U.S. Cl. CPC G06Q 30/0279; G07C 13/00

(57) ABSTRACT

A web-site based computerized system is provided for managing the distribution of donations of corporate donors to different third-party beneficiaries. The system comprises: a beneficiary database (10) containing data on a multiplicity of third-party beneficiaries/charities; a corporate donor platform (20) with web pages each accessible to a given corporate donor; a voting platform (30) with web pages each accessible to a voter, typically an employee or a customer; and a donation-distribution module (40) arranged to provide data for distributing donations to selected third party beneficiaries/charities. The votes cast for different charities are compounded to produce the distribution data.

### FIELD OF THE INVENTION

This invention relates to a web-site based computerized system for managing the distribution of donations of corporate donors to different third-party beneficiaries, in particular charities.

### BACKGROUND ART

WO2009/136362 published 12 Nov. 2009 discloses a system and method for managing the generation and the collection of financial contributions from holders of payment cards and for distributing the collected contributions among a plurality of beneficiaries such as charities selected by the cardholders. A similar system is reported in US20210/0145812 published 10 Jun. 2010.

WO2011/050684, published 12 May 2011, discloses computerized systems and methods for the distribution of donations to a plurality of beneficiaries, for example charities and briefly discloses that employees using payroll giving schemes can donate money directly from the salary paid via the company payroll according to adoptable “personal donation profiles” established by the employees.

### SUMMARY OF THE INVENTION

According to the invention there is provided a web-site based computerized system for managing the distribution of donations of corporate donors to different third-party beneficiaries such as charities.

An aim of this system is to provide a means for corporate entities who make charitable contributions to involve typically their employees in the decision making as to what charities should be funded and in which proportions, which system can be simply implemented and in such a way that the employees (or other voters) participate and hence generate goodwill while creating no or minimal costs over and above the amount of the charitable contribution. Empowering the workforce in this way is good for staff morale and improves employee retention and recruitment. Making charitable donations using the inventive system is an expression of corporate social responsibility and promotes the image of a “fair giving employer”.

The inventive system comprises: a beneficiary database containing data on a multiplicity of third-party beneficiaries; a corporate donor platform comprising web pages each accessible to a given corporate donor; a voting platform comprising web pages each accessible to a voter; and a donation-distribution module arranged to provide data for distributing donations to selected third party beneficiaries.

The inventive system is configured such that the corporate donor platform is arranged so a dedicated web page of the corporate donor platform is allocated to each corporate donor, enabling a corporate donor, by using its dedicated web page, to perform the following operations: Select, from the multiplicity of third-party beneficiaries, a given number of third-party beneficiaries as eligible beneficiaries each eligible to receive a portion of the donor's donation or donations; Nominate voters and to set up a list of voters, for example in the form of a list of their email addresses that is set up in the dedicated web page of the corporate donor platform; Transfer by email or other means, to voters participating in the voting platform, voter data as well as providing a link to a dedicated voter's web page on the voting platform; Allocate to each nominated voter a number of votes that he/she can cast for the eligible beneficiaries; Establish and store information to be made available to voters participating in the voting platform, including information on the eligible beneficiaries; and Determine and signal the end of a voting period.

Moreover, the inventive system's voting platform is arranged so that: a dedicated web page of the voting platform is allocated to each nominated voter; so each voter web page contains a voting matrix to be populated by charities chosen from a list of the eligible third-party beneficiaries selected by the corporate donor; the voting matrix contains or is associated with indications for prompting the voter to cast his/her votes for those eligible third-party beneficiaries that are selected by the voter and with a distribution of the voter's available votes amongst the selected eligible third party beneficiaries at the choice of the voter, and each voter web page further comprises a command enabling the voter to transmit to the donation-distribution module voting data that represents the result of his/her vote.

Finally, the inventive system's donation-distribution module is arranged: to compile distribution data that determines a distribution of the corporate donor's donation or donations amongst the eligible third party beneficiaries, by combining data representing the magnitude of the combined votes cast by all voters for the respective eligible beneficiaries, as represented by the sum of the voting data transmitted from the voter web pages of all voters; to provide, if required, as voting progresses, interim distribution data or statistics on voting to date, in response to receipt of voting data from different voters; and/or so as to compile the distribution data or to finalize compiling the distribution data in response to a signal from the corporate donor platform that determines the end of a voting period.

### BRIEF DESCRIPTION OF THE DRAWINGS

The invention will now be described by way of example with reference to the accompanying schematic drawings in which:

FIG. 1 is a diagram showing the overall system;

FIG. 2 illustrates the database of beneficiaries and the selection of beneficiaries by a corporate donor;

FIG. 3 is a simplified view of a corporate donor's web page;

FIGS. 4A and 4B illustrate a voting matrix before and after voting, respectively; and

FIG. 5 is a diagram illustrating the principle of calculating a distribution of the corporate donor's donation(s) in the donation-distribution module.

### DETAILED DESCRIPTION

According to the invention there is provided a web-site based computerized system for managing the distribution of donations of corporate donors to different third-party beneficiaries. The corporate donors are typically corporations who wish to involve their employees in deciding to which charities or other third-party beneficiaries they should make donations and how these donations should be distributed. The invention also covers other corporate donors such as clubs and associations as well as retailers operating a loyalty scheme for their customers, political parties and other groups who may wish to donate to charity.

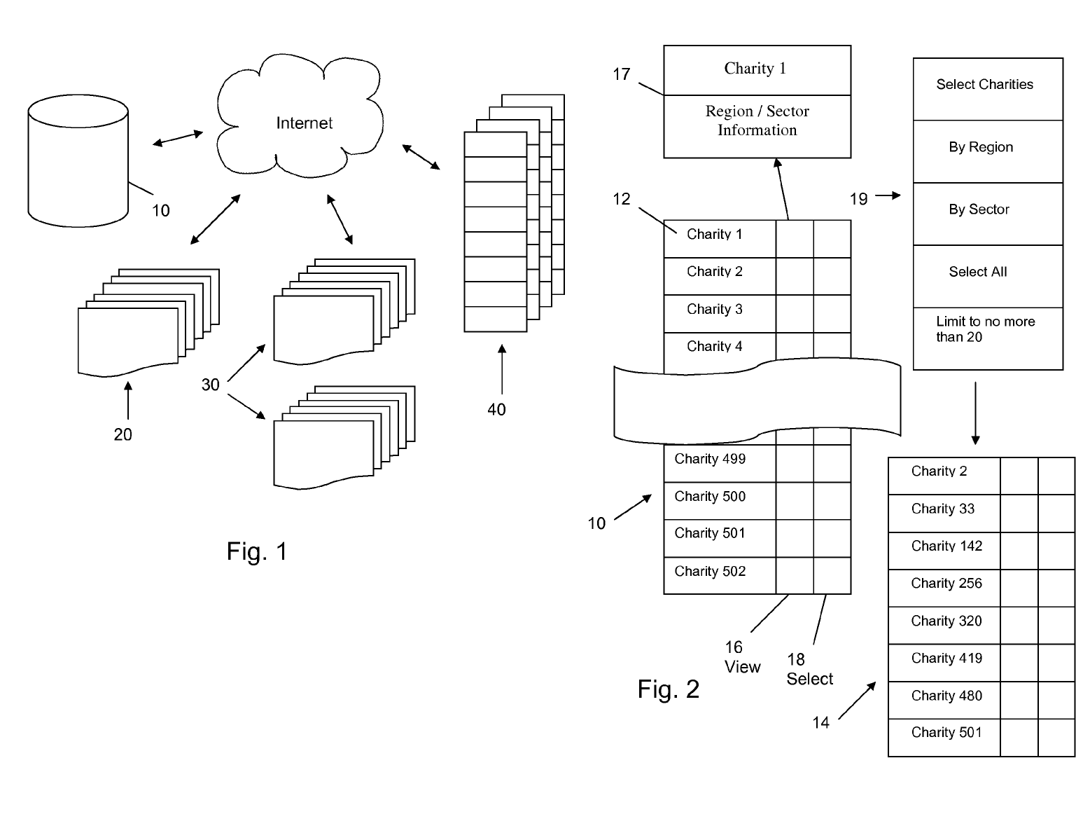

As schematically shown in FIG. 1, the inventive system comprises: a beneficiary database 10 containing data on a multiplicity of third-party beneficiaries/charities; a corporate donor platform 20 comprising web pages each accessible to a given corporate donor; a voting platform 30 comprising web pages each accessible to a voter; and a donation-distribution module 40 arranged to provide data for distributing donations to selected third party beneficiaries/charities.

The inventive system is based on the use of conventional internet/web technology and equipment by which the users (the corporate donor and the voters) can access their web pages and input information using their web browser application. The web sites can be programmed in a conventional way typically using HTML.

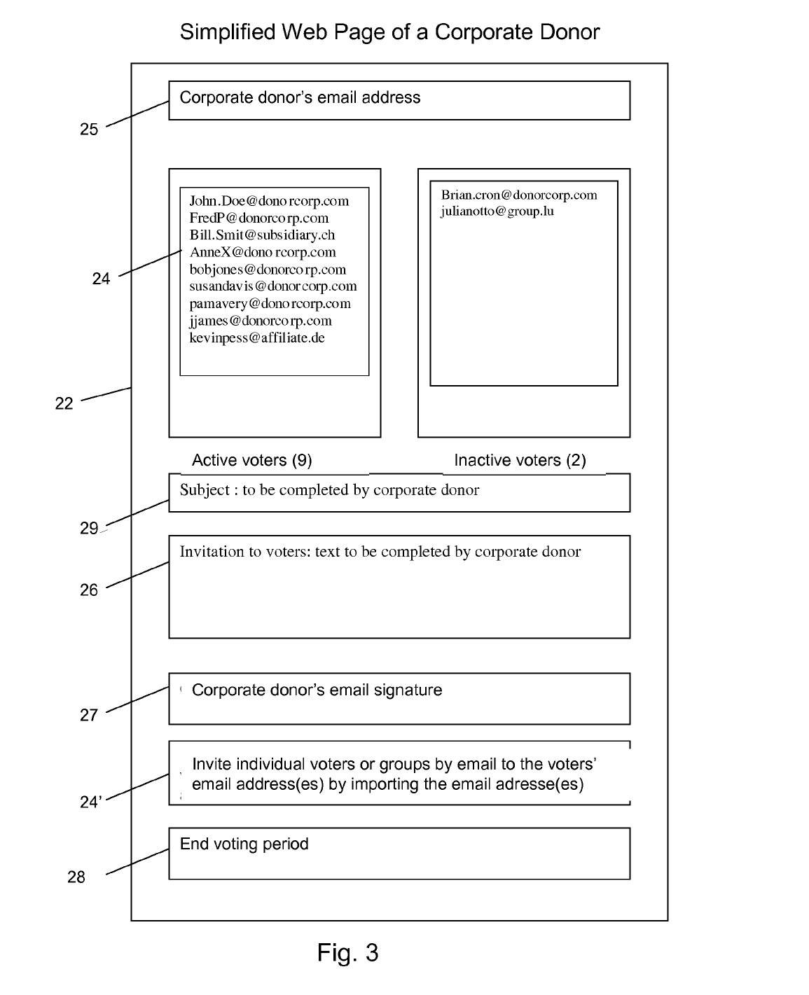

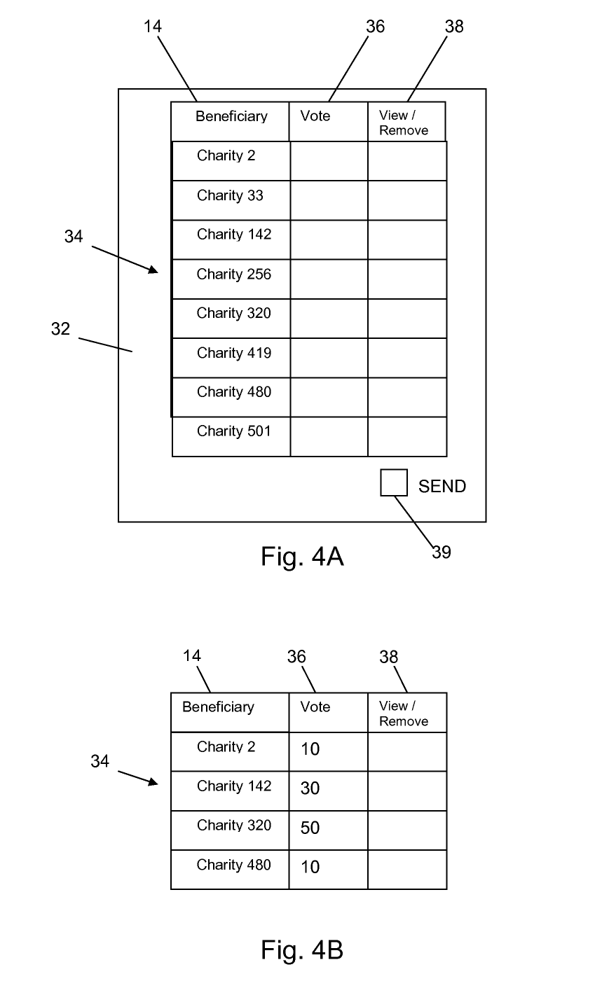

The inventive system is configured such that the corporate donor platform 20 is arranged so a dedicated web page 22 (FIG. 3) of the corporate donor platform is allocated to each corporate donor. This dedicated web page 22 can be branded by the corporate donor affixing the corporate name and corporate logo. A corporate donor, by using its dedicated web page 22 (or an extension thereof), can then perform the following operations.
First, the donor can select, from the multiplicity of third-party beneficiaries 12 in beneficiary database 10, a given number of third-party beneficiaries as eligible beneficiaries 14 (FIG. 2) each eligible to receive a portion of the donor's donation or donations. In the illustrated example, eight eligible charities 14 are selected from a database 10 containing for instance five hundred and two charities. As a matter of fact, the number of charities included in the database 10 is limited only by the storage capacity. In practice, many thousands of charities can be stored if needed, and new charities can be added all the time so the number of charities is ever growing and theoretically unlimited. As shown in FIG. 2, in addition to a listing of the charities 12 the database 10 provides two function columns 16, 18 associated with the respective charities 12. Column 16 operates a view function whereby the user can access a data sheet 17 for each charity one-at-a-time. Data sheet 17 for instance indicates the Charity name, its region (for instance country or US state) and the Sector of charitable activities in which the charity is operative. This data sheet 17 will typically include a charity description, a charity mission statement, a charity website link and keywords. All of this information is provided by the charity when it is registered in the system and can be made available in several languages. Column 18 operates a selection function, i.e. to select that charity as an eligible one. Charity selection is illustrated at 19, i.e. by region, by sector and possibly by activating “Select All” in which case all charities are available. There is also a function “Limit to no more than 20” which provides for a convenient maximum number of charities, for example up to twenty charities, making up the eligible list 14. Hence selection by the corporate donor of a short list of eligible charities from the long list of available charities is greatly simplified.
Second, the web page 22 is arranged so the donor can nominate voters and to set up a list of voters, in the form of a list 24 (FIG. 3) of their email addresses that is set up in the dedicated web page 22 of corporate donor platform 20. FIG. 3 shows the list of voters email addresses divided into two section, active voters and inactive voters. The active status can be activated as a result of feedback of voting data from the voters.
Third, the web page 22 is arranged so the donor can transfer by email (as by the Invitation box 24′), to voters participating in the voting platform, voter data as well as a link to a dedicated voter's web page 32 (FIG. 4A) on the voting platform 30.
Fourth, the donor can allocate to each nominated voter a number of votes that he/she can cast for the eligible beneficiaries 14. This number of votes can be communicated to the voter either in voter information sent with an invitation 24′, or by being indicated on the voter web page 32. Allocated votes can for example be equal in measure for all voters nominated by a corporate donor, or for example weighted according to an employee's length of service, position in a company, age or other distinguishing factor. Another example is where the corporate donor is a retailer operating a loyalty scheme and where votes are attributed to different customers based on loyalty parameters such as spending or loyalty points.
Fifth, the donor web page 22 has provision enabling the donor to establish information that is stored in the web page 22, as in the invitation 26 to voters, which information is to be made available to voters participating in the voting platform 30, including information on the eligible beneficiaries 14.
Sixth, the donor web page 22 (or elsewhere on the site) has means enabling the donor to determine and signal the end of a voting period by command 28.

The donor web page 22 can also contain other useful information or functions, such as the corporate donor's email address 25 and email signature 27 as well as a subject box 29 to be completed by the donor for inclusion in communications to the voters.

The inventive system's voting platform 30 is arranged as follows. A dedicated web page 32 of the voting platform 30 is allocated to each nominated voter for each corporate donor. Thus, for each new corporate donor web page 22 that is opened, the donor creates a number of voter pages 32 corresponding to the number of voters that accept invites.

In one option, each voter web page 32 starts off empty and will be populated by charities a voter chooses from the list of eligible third-party beneficiaries 14 selected by the corporate donor. For this, the web page 32 is linked to the donor platform 20 so that said list is viewable by the voter from the voter login web page 32 by virtue of the platform 30 recognizing that the particular voter is associated with that particular donor's Plan. The voting matrix 34 contains or is associated with indications for prompting the voter to cast his/her (e.g. 100/100%) votes for those eligible third-party beneficiaries 14 that are selected by the voter and with a distribution of the voter's available votes amongst the selected eligible third party beneficiaries at the choice of the voter. Each voter web page 32 further comprises a command 39 enabling the voter to transmit to the donation-distribution module 40 voting data that represents the result of his/her vote. Possible additional functions include the voter reviewing his/her choice of charity, removal of previously chosen charities and changes in distribution of votes.

In an alternative example, illustrated in FIG. 4A, the voting matrix 34 contains a full list of all of the eligible charities selected by the corporate donor. For instance, the voting matrix 34 comprises three columns, a left-hand column listing the eligible beneficiaries, for instance the eight charities selected in FIG. 2; a middle column 36 for casting a vote for any of the eligible beneficiaries with weighting of the vote (e.g. the number of votes out of a hundred); and a right-hand column 38 “View/Remove”. The latter command can be used by the voter to review details of any charity he/she may have previously chosen, it being noted that in all cases the only votes that will count are those cast at the close of a voting period. Thus the command 38 can be used to access details of the eligible charities and to obtain information to assist in the voting decision. If an eligible charity is not to be selected the voter actuates the remove command 38 and that charity is removed from the list.

FIG. 4B shows the voting matrix 34 after non-selected charities have been removed (or not included in the first place, such that only four selected charities are downloaded into the voting matrix), and after votes have been cast for the four selected charities. This example presupposes that 100 votes are available, which is a common case. The number of available votes can be set by the system or, as previously described, a choice of different numbers of votes can be left for the donor to select if desired.

As shown in FIG. 4A, the voter web page can include further commands such as the SEND button 39 that can be actuated when voting is finished, to save the result of the vote and send it to the donation-distribution module 40. Other possible functions include a command that will spread votes evenly amongst the selected charities on request. This can conveniently be made a default setting. It is noted that a voter can change the selection or distribution of votes multiple times within the voting period as the only votes that count are those in force at the close of a voting period, which will usually be sometime before a donation is determined.

The voting result which is output from the web page 32 digitizes the numbers entered in the voting column 36 and sends each digital vote with an identification of the selected charity.

The inventive system's donation-distribution module 40 is arranged to compile distribution data that determines a distribution of the corporate donor's donation or donations amongst the eligible third party beneficiaries 14, b y combining data representing the magnitude of the combined votes cast by all voters for the respective eligible beneficiaries, as represented by sum of the voting data transmitted from the voter web pages 32 of all voters.

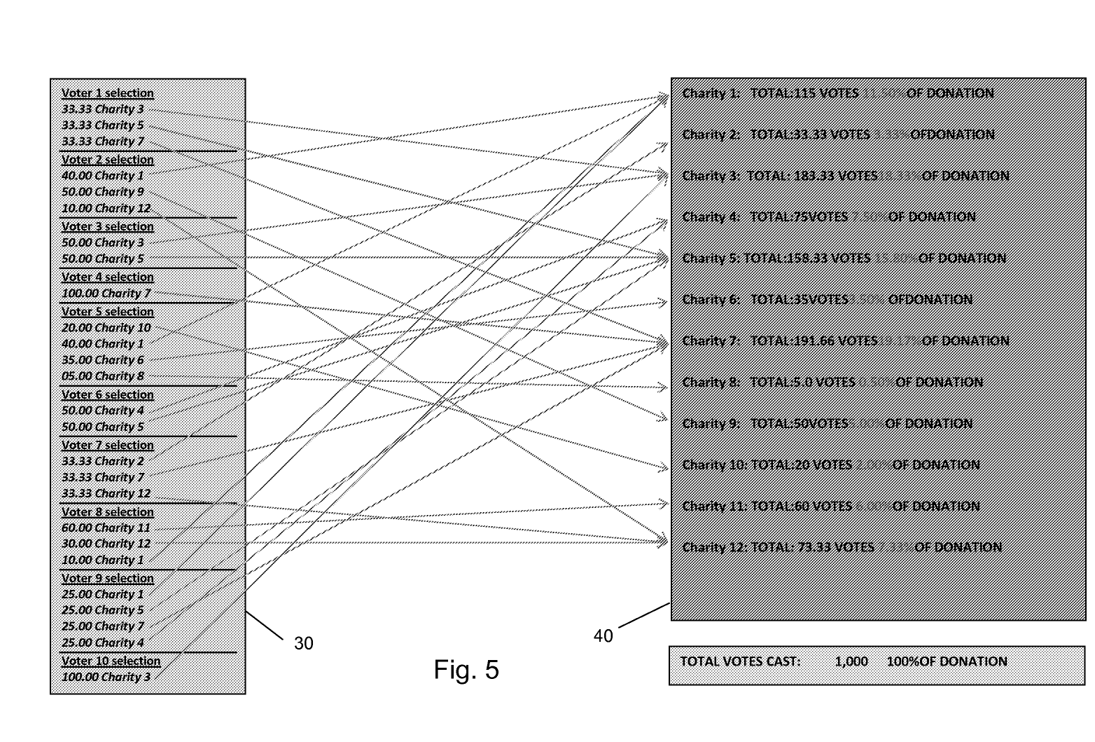

This is illustrated by way of example in FIG. 5 which shows how the weighted voting distribution module 40 works. FIG. 5 represents a simplified example with a company plan of twelve eligible charities and for example ten voters.

The ten voters with their voter selections are shown in the voting platform 30. The twelve charities with the resulting distribution of the donation are shown in the donation-distribution module 40. The arrows joining the voting platform 30 to the donation-distribution module 40 represent how the voting data is distributed amongst the charities. For example, voter #1 has cast votes for charities #3, #5 and #7 so the corresponding voting data (33.33 votes each) is dispatched to these charities in the donation-distribution module 40 and likewise for the voting data of charities #2-10, as indicated by the arrows.

At the donation-distribution module 40, charity #1 receives voting data from voter #2 (40 votes), from voter #5 (40 votes), from voter #8 (10 votes) and from voter #9 (25 votes) making in total 115 votes for charity #1. Likewise, charity #2 receives in total 33.33 votes, charity #3 receives 183.33 votes and so on down to charity #12 that receives a total of 73.33 votes, all as indicated by the arrows leading to the respective charities in the donation-distribution module 40. These vote totals are then converted to percentage figures which represent the distribution data of the donation between the charities, namely 11.50% for charity #1 to 7.33% for charity #13, as indicated.

If required, donation-distribution module 40 provides, as voting progresses, interim distribution data or statistics on voting to date, in response to receipt of voting data from different voters. Interim distribution data would be an indication of the notional distribution of donations according to the number of voters who have voted to date. Typical statistics would be the number of voters having voted to date. The donation-distribution module 40 is arranged so as to compile the distribution data or to finalize compiling the distribution data (in case interim results were already available), this in response to a signal 28 from the corporate donor platform that determines the end of a voting period. Once voting is over, the distribution data is definitive and can be used to distribute the donation or donations amongst the selected beneficiaries.

This final distribution data can be processed in different ways. In one example, the distribution data is transferred to the corporate donor who is left to distribute its donation(s) amongst the selected charities in the given proportions. In another example, the operator of the system receives one or several payments from the donor and then distributes to the charities according to the distribution data. This is advantageous in particular in the case where the donation-distribution module is arranged to combine distribution data provided from the voters of different corporate donors. The latter example is to be preferred since the system can combine the distribution of payments from different corporate donors thus simplifying the payment of small amounts to given charities selected by the votes for different corporate donors.

As mentioned, the donor web page 22 can indicate active and passive voters. For this purpose, the donation-distribution module 40 and/or the voting platform 30 is/are arranged to provide to the corporate donor platform 20 feedback on voting as voting progresses as well as allowing reminders to be sent to inactive voters. Furthermore a “voting results” page (not shown) can be provided to the donor, indicating the combined votes collected for each of the charities in the donor plan at any given time. It is noted that voters may change their votes multiple times leading up to the end of a voting period, which may be pre-determined or left “open-ended”.

Implementation of the described inventive system is simple. When a corporation, for example, wants to have its employees empowered to select charities and to determine the distribution of a charitable donation, it can register in the system by providing its email address and creating a password and then select a group of charities as eligible to receive its donation. It then fills in information to complete its web page 22 and selects all or a group of employee voters by entering their email addresses (24′) and sending them an invitation to participate. When the employees cast their votes the voting data is sent to the donation-distribution module 40 where the distribution of the future donation(s) is calculated according to the votes cast, at the end of voting. In this simple way the employees participate in the decision-taking process in a motivating way and the fluid nature of the platform results in a changeable voting profile effectively reflecting the “charitable DNA” of the voting element of the workforce at any given time.

As used herein, “dedicated web page” encompasses a single dedicated web page or more than one dedicated web page.

1. A web-site based computerized system for managing the distribution of donations of corporate donors to different third-party beneficiaries, the system comprising:
(a) a beneficiary database containing data on a multiplicity of third-party beneficiaries;
(b) a corporate donor platform comprising web pages each accessible to a given corporate donor;
(c) a voting platform comprising web pages each accessible to a voter; and
(d) a donation-distribution module arranged to provide data for distributing donations to selected third party beneficiaries,
wherein the system is configured such that
(i) the corporate donor platform is arranged so at least one dedicated web page of the corporate donor platform is allocated to each corporate donor, enabling a corporate donor, by using its dedicated web page(s), to:
select, from said multiplicity of third-party beneficiaries, a given number of third-party beneficiaries as eligible beneficiaries each eligible to receive a portion of the donor's donation or donations;
nominate voters and to set up a list of voters;
transfer by email, to voters participating in the voting platform, voter data as well as a link to a dedicated voter's web page on the voting platform;
allocate to each nominated voter a number of votes that he/she can cast for the eligible beneficiaries;
establish and store information to be made available to voters participating in the voting platform, including information on the eligible beneficiaries; and
determine and signal the end of a voting period;
(ii) the voting platform is arranged so that:
at least one dedicated web page of the voting platform is allocated to each nominated voter;
at least one voter web page is capable of being populated by a voting matrix comprising charities chosen from a list of the eligible third-party beneficiaries selected by the corporate donor;
the voting matrix contains or is associated with indications for prompting the voter to cast his/her votes for those eligible third-party beneficiaries that are selected by the voter and with a distribution of the voter's available votes amongst the selected eligible third party beneficiaries at the choice of the voter, and
at least one voter web page further comprises a command enabling the voter to transmit to the donation-distribution module voting data that represents the result of his/her vote; and
(iii) the donation-distribution module is arranged:
to compile distribution data that determines a distribution of the corporate donor's donation or donations amongst the eligible third party beneficiaries, by combining data representing the magnitude of the combined votes cast by all voters for the respective eligible beneficiaries, as represented by the sum of the voting data transmitted from the voter web pages of all voters;
and so as to compile the distribution data or to finalize compiling the distribution data in response to a signal from the corporate donor platform that determines the end of a voting period.

2. The system of claim 1, wherein the beneficiary database comprises a list of all beneficiaries and a function enabling the corporate donor or voters to have selective access to detailed information on each beneficiary.

3. The system of claim 2, wherein said detailed information on each beneficiary includes information by region and by sector of activities.

4. The system of claim 1, wherein the corporate donor platform is provided with a function that limits the number of beneficiaries that can be selected as eligible beneficiaries.

5. The system of claim 4, wherein the number of beneficiaries that can be selected as eligible beneficiaries is selectable to be no more than twenty.

6. The system of claim 1, wherein the dedicated webpage of the corporate donor platform is arranged for setting up a list of voters in the form of a list of their email addresses in the dedicated web page of the corporate donor platform.

7. The system of claim 1, wherein the voting matrix comprises, in addition to the list of eligible third-party beneficiaries presented as a column, a corresponding additional column for casting votes and a further corresponding column enabling the voter to consult information on selected beneficiaries, which information is stored in the beneficiary data base.

8. The system of claim 7, wherein said further column of the voting matrix enables the voter to add or remove from the voting matrix a beneficiary that for example has been previously chosen from the eligible third party beneficiaries.

9. The system of claim 1, wherein the donation-distribution module is arranged to provide as voting progresses, interim distribution data or statistics on voting to date, in response to receipt of voting data from different voters.

10. The system of claim 1, wherein the donation-distribution module and/or the voting platform is/are arranged to provide to the corporate donor platform feedback on voting as voting progresses.

11. The system of claim 1, wherein the donation-distribution module is arranged to combine distribution data provided from the voters of different corporate donors.
